(19) United States
(12) Patent Application Publication
(10) Pub. No.: US 2026/0249753 A1
(43) Pub. Date: Aug. 27, 2026

(54) CHILD RESTRAINT SYSTEM WITH SWIVEL BASE ROTATION MECHANISM

(71) Applicant: Britax Child Safety, Inc., Fort Mill, SC (US)

(72) Inventors: Quentin Walsh, Fort Mill, SC (US); Mitchell Shellenberger, Mount Joy, PA (US); Michael Calvert, Fort Mill, SC (US); Angela Stacey, St. John’s (CA)

(21) Appl. No.: 19/546,742

(22) Filed: Feb. 23, 2026

Related U.S. Application Data
(60) Provisional application No. 63/761,599, filed on Feb. 21, 2025.

(51) Int. Cl. B60N 2/28

(52) U.S. Cl. CPC B60N 2/2821; B60N 2/2869

(57) ABSTRACT

A child seat configured to be secured to a car seat is provided. The child seat includes a seat pivotably coupled to a base. The seat includes a rotating portion and a stationary portion. The rotating portion is adjustable between a locked position and an unlocked position. In a locked position, the rotating portion cannot rotate in relation to the stationary portion. In an unlocked position, the rotating portion is configured to rotate in relation to the stationary portion. The child seat may further include a mechanism to prevent the seat from adjusting between the first position and the second position.

### PRIORITY CLAIM AND CROSS-REFERENCE TO RELATED APPLICATION

The present application claims priority to and the benefit of U.S. Provisional Patent Application No. 63/761,599 filed February 21, 2025, which is incorporated herein by reference in its entirety and relied upon.

### BACKGROUND

Child restraint systems, also commonly called child safety seats, child seats, car seats, or booster seats, among others, are designed to protect children in vehicles from the effects of impacts or sudden changes in motion (e.g., sudden acceleration, sudden deceleration, and the like). Child restraint systems, referred to hereinafter as child seats, may be used in a variety of vehicles with different seat types and/or seating configurations. It is important for a child seat to be properly secured to the vehicle (e.g., car) seat to protect the occupant. It is also important for the occupant to be properly secured to the child seat. However, it is common for child seats to be installed or used improperly. For example, a user may be required to secure the child seat to a vehicle seat with limited space, making it difficult to maneuver the child seat to assure proper securement. In such situations, a user may find it awkward and difficult to correctly buckle and maintain a proper amount of tension. In such situations, an improper amount of belt tension is undesirable and may negatively affect the safety of the occupant within the child seat.

### SUMMARY

The present disclosure relates to child restraint systems and, more particularly, to child restraint systems with a swivel base rotation mechanism.

Aspects of the subject matter described herein may be useful alone or in combination with one or more other aspects described herein. In an exemplary aspect of the present disclosure, a child seat is configured to be secured to a vehicle seat. The child seat includes a seat pivotably coupled to a base. The seat includes a rotating portion and a stationary portion. The rotating portion is adjustable between a locked position and an unlocked position with a swivel base rotation mechanism. In the locked position, the swivel base rotation mechanism prevents the seat from adjusting between a forward-facing configuration, a side facing configuration, and a rear facing configuration. In the unlocked position, the seat is adjustable between the forward-facing configuration, the side facing configuration, and the rear facing configuration.

In a second aspect of the present disclosure, which may be combined with any other aspect listed herein unless specified otherwise, the swivel base rotation mechanism further includes a shaft, a latch, a side hand, and a secondary lock. The shaft is attached to the stationary portion. The latch is connected to the shaft. The side handle and the secondary lock are coupled to the latch. The side handle and the secondary latch are flush on the seat.

In a third aspect of the present disclosure, which may be combined with any other aspect listed herein unless specified otherwise, the swivel base rotation mechanism, in response to rotating the handle around an axis and pushing the secondary lock into the seat, the latch moves the shaft, adjusting the swivel base rotation mechanism to the unlocked position.

In a fourth aspect of the present disclosure, which may be combined with any other aspect listed herein unless specified otherwise, the latch includes a first latch end, a second latch end, and a latch body. The first latch end is coupled to the secondary lock. The second latch end is coupled to the shaft. The latch body is coupled to the side handle.

In a fifth aspect of the present disclosure, which may be combined with any other aspect listed herein unless specified otherwise, the shaft comprises a cavity and the rotating portion comprises a tooth. The cavity is configured to engage the tooth when the seat is in the locked position.

In a sixth aspect of the present disclosure, which may be combined with any other aspect listed herein unless specified otherwise, the seat is in the unlocked position when the tooth is disengaged from the cavity.

In a seventh aspect of the present disclosure, which may be combined with any other aspect listed herein unless specified otherwise, the base comprises an indicating window.

In an eight aspect of the present disclosure, which may be combined with any other aspect listed herein unless specified otherwise, the swivel base rotation mechanism comprises a first side handle, a second side handle, a first secondary lock, and a second secondary lock. The first side handle and the first secondary lock is configured to adjust the swivel base rotation mechanism from the locked position to the unlocked position The second side handle and the second secondary lock is configured to adjust the swivel base rotation mechanism from the locked position to the unlocked position.

In a ninth aspect of the present disclosure, which may be combined with any other aspect listed herein unless specified otherwise, the tooth includes a tooth base. The tooth base comprises a tooth base first side, a tooth base second side, a tooth base top, and a tooth base bottom.

In a tenth aspect of the present disclosure, which may be combined with any other aspect listed herein unless specified otherwise, the cavity further includes a cavity first side, a cavity second side, and a cavity bottom.

The presently disclosed invention further includes a method of rotating a child seat comprising a swivel base rotation mechanism. The child seat comprises a seat pivotably coupled to a base. The seat comprises a rotating portion and a stationary portion. The swivel base rotation mechanism is adjustable between a locked position and an unlocked position. In the locked position, the swivel base rotation mechanism prevents the seat from adjusting between a forward-facing configuration, a side facing configuration, and a rear facing configuration. In the unlocked position, the seat is adjustable between the forward-facing configuration, the side facing configuration, and the rear facing configuration. The swivel base rotation mechanism comprises a shaft and a latch. The latch comprises a first latch end, a second latch end, and a latch body. The second latch end is coupled to the shaft.

In a twelfth aspect of the present disclosure, which may be combined with any other aspect listed herein unless specified otherwise, the first latch end is coupled to a secondary lock.

In a thirteenth aspect of the present disclosure, which may be combined with any other aspect listed herein unless specified otherwise, the latch body is coupled to a side handle.

In a fourteenth aspect of the present disclosure, which may be combined with any other aspect listed herein unless specified otherwise, actuating the shaft comprises a cavity.

In a fifteenth aspect of the present disclosure, which may be combined with any other aspect listed herein unless specified otherwise, the cavity is configured to engage a tooth.

In a sixteenth aspect of the present disclosure, which may be combined with any other aspect listed herein unless specified otherwise, a swivel base rotation mechanism for use with a child safety seat, the swivel base rotation mechanism including a shaft attached to a stationary portion, a latch connected to the shaft, a side handle coupled to the latch, and a secondary lock coupled to the latch, the side handle and the secondary lock are flush on a child safety seat, the swivel base rotation mechanism is adjustable between a locked position and an unlocked position,, in the locked position, the swivel base rotation mechanism prevents the child safety seat from adjusting between a forward-facing configuration, a side facing configuration, and a rear facing configuration, and, in the unlocked position, the seat is adjustable between the forward-facing configuration, the side facing configuration, and the rear facing configuration.

In a seventeenth aspect of the present disclosure, which may be combined with any other aspect listed herein unless specified otherwise, in response to rotating the handle around an axis and pushing the secondary lock into the seat, the latch moves the shaft, adjusting the swivel base rotation mechanism to the unlocked position.

In an eighteenth aspect of the present disclosure, which may be combined with any other aspect listed herein unless specified otherwise, the latch has a first latch end, a second latch end, and a latch body, and the first latch is coupled to the secondary lock, the second latch end is coupled to the shaft, and the latch body is coupled to the side handle.

In a nineteenth aspect of the present disclosure, which may be combined with any other aspect listed herein unless specified otherwise, the shaft includes a cavity and the rotating portion includes a tooth, the cavity is configured to engage the tooth when the child safety seat is in the locked position.

In a twentieth aspect of the present disclosure, which may be combined with any other aspect listed herein unless specified otherwise, when the seat is in the unlocked position, the tooth is disengaged from the cavity.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE FIGURES

The specification makes reference to the following appended figures, in which use of like reference numerals in different figures is intended to illustrate like or analogous components.

FIG. 1 illustrates a front perspective view of an example child seat in a front facing configuration, according to various embodiments.

FIG. 2 illustrates a side view of an example child seat in a front facing configuration while in a closed position, according to various embodiments.

FIG. 3 illustrates a front perspective view of an example child seat in a front facing configuration, according to various embodiments.

FIG. 4 illustrates an upper perspective view of an example child seat in a front facing configuration, according to various embodiments.

FIG. 5 illustrates a zoomed in view of an embodiment of a swivel base rotation mechanism, according to various embodiments.

FIG. 6 illustrates a zoomed in view of an embodiment of a swivel base rotation mechanism, according to various embodiments.

FIG. 7 illustrates zoomed in view of an embodiment of a swivel base rotation mechanism, according to various embodiments.

FIG. 8 illustrates a zoomed in top perspective view of an alternate secondary lock embodiment of the side handle and the secondary lock, according to various embodiments.

FIG. 9 illustrates a zoomed in bottom perspective view of the alternate secondary lock embodiment of the side handle and secondary lock, according to various embodiments.

FIG. 10 illustrates a zoomed in side perspective view of the alternate secondary lock embodiment of the side handle and secondary lock, according to various embodiments.

FIG. 11 illustrates an exploded view of a sliding mechanism between a lock blocker and a side handle actuator in the alternate secondary lock embodiment, , according to various embodiments.

### DETAILED DESCRIPTION

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the FIGURE(or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12.” In the figures and the description, like numerals are intended to represent like elements.

A child seat may be configured for installation based on the height and weight of a child and according to various guidelines and standards, such as those of the United States National Highway Transportation Safety Administration. To ensure maximum protection for an occupant of the child seat, the child seat must be secured to a fixed location in a vehicle, such as using a seat belt of the car seat or Lower Anchors and Tethers for Children (“LATCH”) attachments. When a user is securing a child in a car seat, a user is required to properly position and secure the occupant in the child seat of a vehicle with limited space, making it difficult to maneuver the occupant and properly position the safety components. With additional space, the chances of proper installment may increase, providing safer conditions for the occupant of the child seat during transport. When seat belts or safety belts attached to the child seat are used to secure the occupant in the child seat, slack in the belt may often occur, and such slack causes the occupant to be loosely secured to the child seat, which presents an unsafe condition for the occupant of the child seat. A user must be able to properly secure the occupant in the car seat to ensure the occupant

Described herein are swivel base rotation mechanisms for child seats that provide the ability to rotate the child seat. In certain aspects, the swivel base rotation mechanism described herein may adjust the child seat to prove the user easier access to the occupant. Other swivel base rotation mechanisms may allow a user to unlock the child seat to allow for rotation. The swivel base rotation mechanism may allow the user to ensure the child seat is in a locked position such that the child seat cannot rotate. The swivel base rotation mechanism may be configured to provide the user with a mechanical advantage, to ensure the occupant is securely positioned in the child seat with minimal required effort. Various other advantages and benefits may be realized with the swivel base rotation mechanism described herein, and the aforementioned benefits and advantages should not be considered limiting.

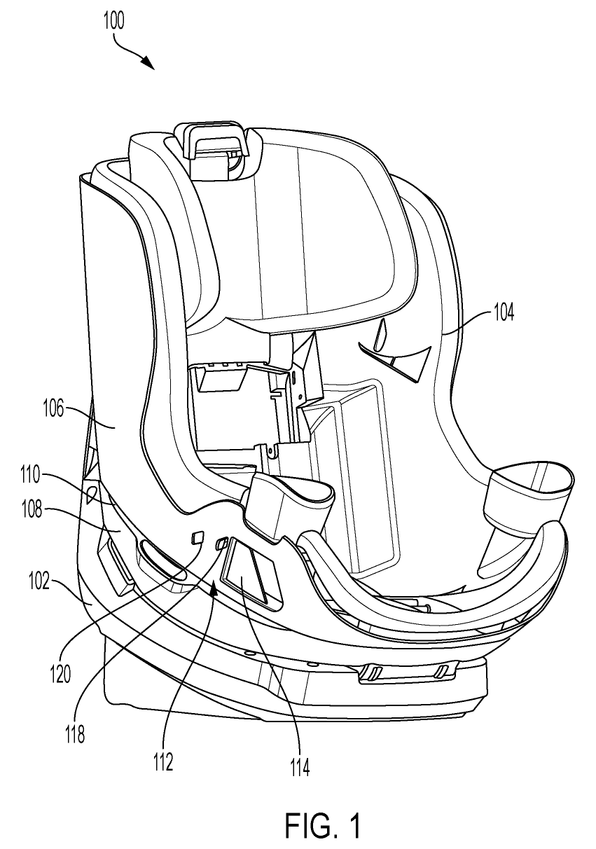

FIG. 1 illustrates a front perspective view of an example child seat in a forward-facing configuration, according to various embodiments. In the illustrated embodiment, the child seat 100 is an infant car seat in a forward-facing configuration. The child seat 100 includes a base 102 and a seat 104. The seat 104 further includes a rotating portion 106 and a stationary portion 108 that interface at a seam 110. Specifically, the rotating portion 106 is located above the seam 110 while the stationary portion 108 is located below the seam 110. The stationary portion 108 is fixed to the base 102, and the rotating portion 106 is configured to rotate in relation to the stationary portion 108.

Because the rotating portion 106 rotates in relation to the stationary portion 108, the user may adjust the child seat 100 to various positions. For example, the user may rotate the child seat 100 into a rear facing configuration. The user may also rotate the child seat 100 into a side facing configuration. The side facing configuration provides ease of access for the user to load or unload an occupant into the seat 104. Once the occupant is secured to the seat 104, the user may then rotate the seat 104 to the front facing configuration or the rear facing configuration during transport. In other embodiments, the seat 104 may be fixed to the base 102, and the base 102 may be provided with other types of child seats, including a convertible car seat or a three-in-one car seat.

The seat 104 may further include a swivel base rotation mechanism 112 comprises a variety of components where some are disposed on the rotating portion 106 and some are disposed on the secondary portion 108. The swivel base rotation mechanism 112 includes a locked position and an unlocked position. In the locked position, the rotating portion 106 is unable to rotate about the stationary portion 108 of the seat 104. The locked position may be used during transport to prevent the rotating portion 108 from rotating about the stationary portion 108. In the unlocked position, the rotating portion 106 can rotate about the stationary portion 108 of the seat 104. Thus, the user may adjust the child seat 100 to various positions when the swivel base rotation mechanism 112 is in the unlocked position. The swivel base rotation mechanism 112 includes a side handle 114, a latch 116 (not shown here), a shaft 112, a tooth 123, and a cavity 124 configured to adjust the swivel base rotation mechanism 112 between the locked position and the unlocked position. It should be appreciated that there can be more than one side handle 114 which may be in any number of positions.

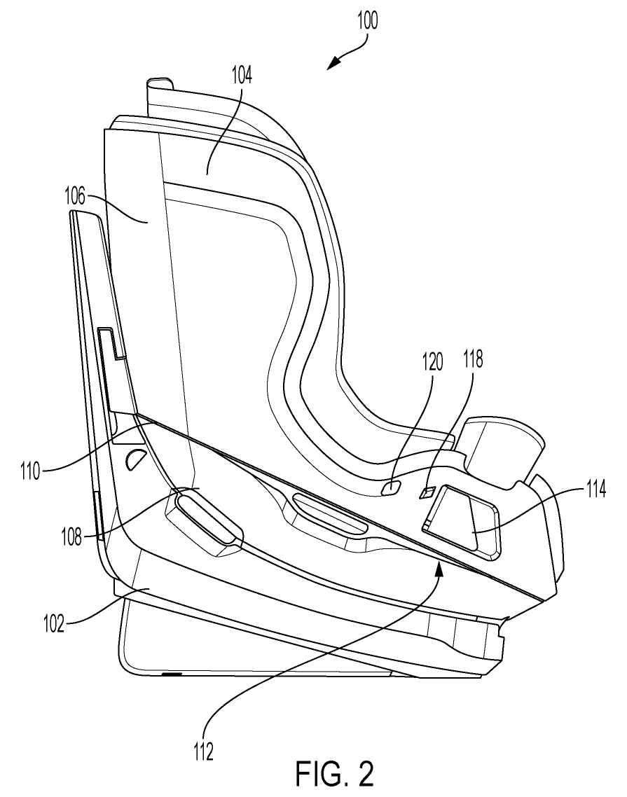

FIG. 2 illustrates a side view of an example child seat in a front facing configuration while in a closed position, according to various embodiments. The child seat 100 can be adjusted between a forward-facing configuration, side facing configuration, and a rear facing configuration. In FIG. 2, the child seat 100 is in the locked position. When the child seat 100 is adjusted from the locked position to the unlocked position, the rotating portion 106 rotates about the stationary portion 108 clockwise or counterclockwise. By rotating the about the stationary portion 108, the user is able to adjust the configuration of the child seat 100 such that the user can properly secure the occupant in the child seat 100. Once the occupant is properly installed, the user can adjust the seat 104 to the locked position by pivoting the rotating portion 106 to the forward-facing configuration.

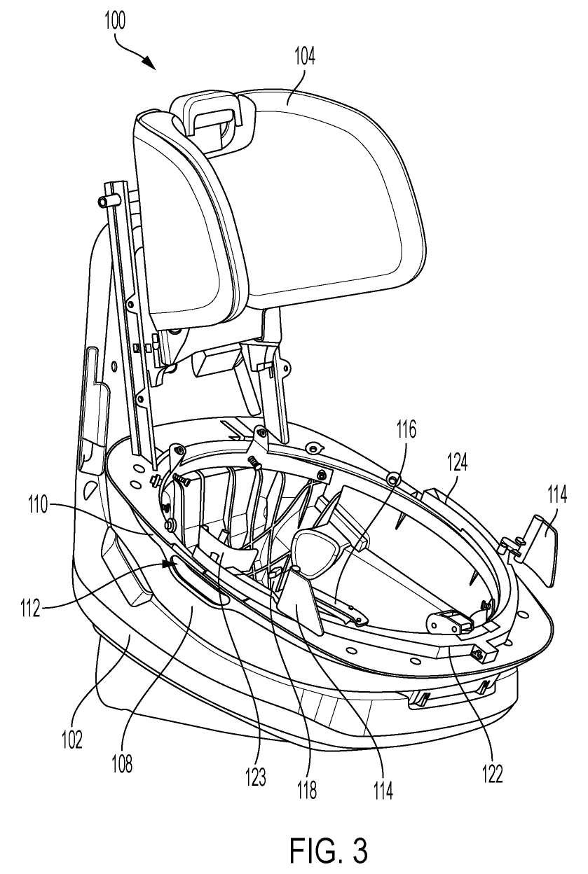

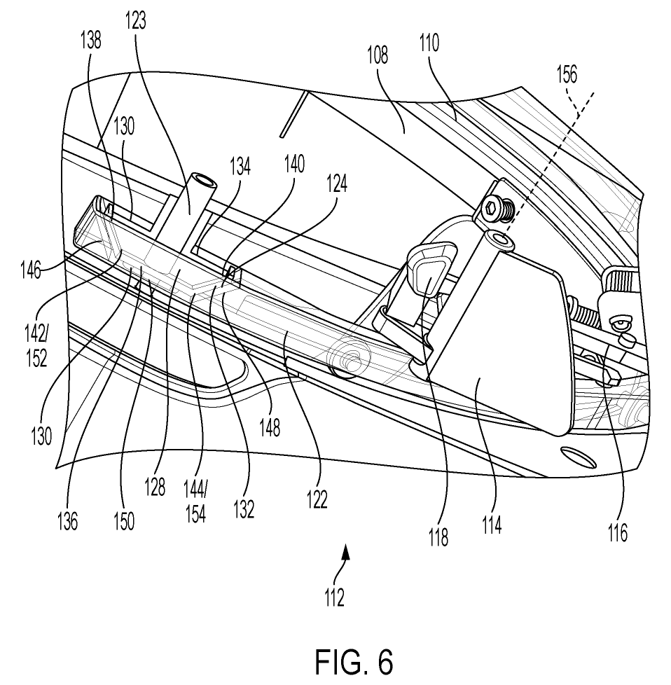

FIG. 3 illustrates a front perspective view of an example child seat in a front facing configuration, according to various embodiments. For illustrative purposes, the rotating portion 106 has been removed in FIG. 3. Continuing on, the swivel base rotation mechanism 112 includes a side handle 114 secured to a latch 122 which is secured to a shaft 122. The latch 122 is flush with the seat 104. The swivel base rotation mechanism 112 also includes a secondary lock 118 secured to a latch which is secured to a shaft 122. The shaft 122 is secured to the stationary portion 108 of the child seat 100. The shaft 122 further includes a cavity 124. The swivel base rotation mechanism 112 also includes a tooth 123 which is secured to the rotating portion 106. The cavity 124 is configured to engage the tooth 123 (shown more clearly in FIG. 6). When the cavity 124 engages the tooth 123, the swivel base rotation mechanism 112 and the rotating portion 106 is in a locked position. When the tooth 123 is disengaged from the cavity 124, the swivel base rotation mechanism 112 and the rotating portion 106 is in an unlocked position. In the unlocked position, the user can adjust the child seat 100 between the forward-facing configuration, the side facing configuration, and the rear facing configuration by pivoting the rotating portion 106 about the stationary portion 108 as described in reference to FIG. 2. In the locked position, the user is unable to adjust the child seat 100 to the side facing configuration or the rear facing configuration.

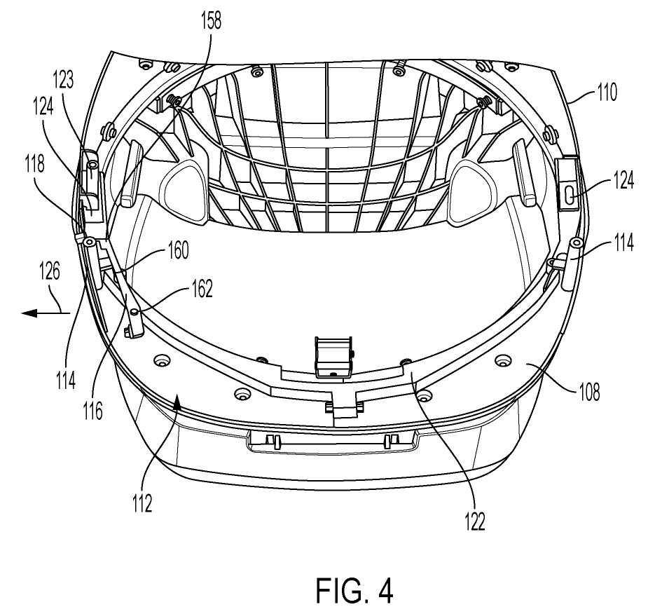

FIG. 4 illustrates a zoomed in view of an example swivel base rotation mechanism of a child seat of FIG. 3, according to various embodiments. As introduced in reference to FIG. 3, the swivel base rotation mechanism 112 includes a side handle 114 secured to a latch 116. The swivel base rotation mechanism 112 also includes a secondary lock 118 secured to the latch 116. The latch is secured to the shaft 122. The shaft 122 is secured to the stationary portion 108 of the child seat 100. The shaft 122 further includes a cavity 124. The swivel base rotation mechanism 112 also includes a tooth 123 which is secured to the rotating portion 106. The cavity 124 is configured to engage the tooth 123. When the cavity 124 engages the tooth 123, the swivel base rotation mechanism 112 is a locked position.

In an illustrative example, the user adjusts the swivel base rotation mechanism 112 from the locked position to the unlocked position. The user must first actuate the secondary lock 188 and then pull the side handle 122 in a direction 126. These consecutive movements cause the latch 116 which is connected to the shaft 122 to move the shaft 122 in a way that disengages the tooth 123 from the cavity 124. The latch 116 is provided by securing the side handle 114 and the secondary lock 118 to the shaft 122. Pulling the side handle 114 and pushing the secondary lock 118 provides a rotational force around an axis 156. The rotational force around the axis 156 is converted to a translational force , translating to the shaft 122. The force translated to the shaft will be an opposing force than the force exerted by the user in the direction 126. The force translating to the shaft 122 causes the shaft 122 including the cavity 124 to disengage the tooth 123. As introduced above, the swivel base rotation mechanism 122 is in the unlocked position when the tooth 123 is disengaged from the cavity 124, allowing the user to rotate the rotating portion 106 of the seat 104 about the stationary portion 108.

In various embodiments, the swivel base rotation mechanism 112 is symmetric. For example, FIG. 4 illustrates a first side of the swivel base rotation mechanism 112. Such swivel base rotation mechanism 112 may include a second side, allowing the user to adjust the swivel base rotation mechanism 112 from either side of the child seat 100. The second side of the swivel base rotation mechanism 112 may include the same components, which function in a manner identical to those described in reference to FIG. 4. As shown in FIG. 4, the swivel base rotation mechanism 112 only includes a second side handle 114 and a second cavity 124 but omits several of the other components required for a symmetrical swivel base rotation mechanism 112. For this illustration, the swivel base rotation mechanism 112 is assumed to have two of each required component on each side of the swivel base rotation mechanism 112.

Further, to facilitate a symmetric pivot swivel base rotation mechanism 120, the swivel base rotation mechanism 120 includes a shaft 122 with a first end and a second end. The first and second ends of the shaft 122 include each required component on either end of the swivel base rotation mechanism 112. For example, the symmetric swivel base rotation mechanism 120 includes a first and second side handle 114, a first and second secondary lock 118, a first and second latch 116, a first and second latch, a first and second tooth 123, and a first and second cavity 124 configured to adjust the swivel base rotation mechanism 112 between the locked position and the unlocked position. Each component will engage with the other corresponding components the same as the example embodiment discussed above. With such design, the user can pull a first handle 122 and a first secondary lock 118 causing the first latch 116 connected to the shaft 122 to move the shaft 122 in a way that disengages the first tooth 123 from the first cavity 124. On the other hand, the user can pull a second handle 122 and a second secondary lock 118 causing the second latch 116 connected to the shaft 122 to move the shaft 122 in a way that disengages the second tooth 123 from the second cavity 124.In other words, the user is only required to pull one of the two side handles 114 and push the corresponding secondary lock 118 to adjust the swivel base rotation mechanism 112 from the locked position to the unlocked position. This allows the user to adjust the child seat from either side, increasing the ease of installation and adjustment.

In an embodiment, each end of the shaft 122 includes a visual indicator. For example, each end of the shaft 122 may include an indicating window 120 that indicates to a user whether the swivel base rotation mechanism is in a locked position or an unlocked position. A portion of the latch 116 is black and a portion of the latch 116 is red. The latch 116 is partially viewable through the shell of base 102, such that the colored portion of the latch 116 can visually indicate to the user, whether the swivel base rotation mechanism 112 is in a locked position or an unlocked position. Knowing which color is an indicator to which position, one can determine the status of swivel base rotation mechanism 112 (i.e., locked or unlocked). As an illustrative example, if the user sees the red in the indicating window 120, the user knows that the latch 116 is disengaged; if the user sees the black portion of the indicating window 120, the user knows that the latch 116 is engaged and the seat is secure. A variety of other indication mechanisms can be used including mechanisms using a latch, switch, words, colors and combinations thereof.

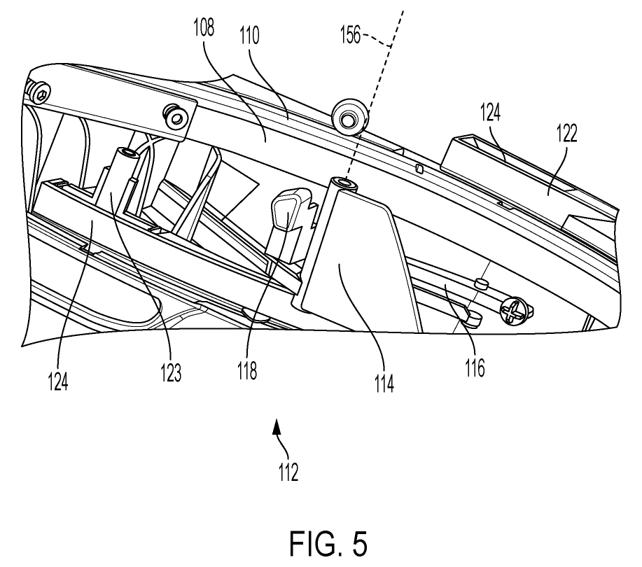

FIG. 6 illustrates a zoomed in view of an example swivel base rotation mechanism 112 in a locked position, according to various embodiments. For illustrative purposes, the shaft 122 is shown as transparent. As described in reference to FIGS. 2 to 5, the user may adjust the child seat 100 into a forward-facing configuration, a side facing configuration, or a rear facing configuration. When transitioning to the unlocked position, the user pulls the side handle 114 and pushes the secondary lock 118 into the seat 104. This allows the rotating portion 106 of the seat 104 to be in the unlocked position. Once the rotating portion 106 is in the unlocked position, the user can rotate the rotating portion 106 about the stationary portion 108 to different configurations. When the user can rotate the rotating portion 106 of the seat 104 to various configurations, the user can access the seat 104 easier and can therefore more easily and properly secure the occupant to the child seat 100.

The tooth 123 of the swivel base rotation mechanism 112 includes a tooth base where the tooth base includes a tooth base first side 130, a tooth base second side 132, a tooth base top 134 and a tooth base bottom 136. The tooth base top 134 and the tooth base bottom 135 are opposite sides. Preferably but not required, the tooth base top 134 and the tooth base bottom 135 are parallel. The tooth base first side 130 and the tooth base second side 132 are opposite sides. The tooth base first side 130 and the tooth base top 134 conjoin at angle a 138. The tooth base second side 132 and the tooth base top 134 conjoin at angle b 140. The tooth base first side 130 and the tooth base bottom 136 conjoin at angle c 142. The tootle base second side 132 and the tooth base bottom 136 conjoin at angle d 144.

Further, the cavity 124 of the swivel base rotation mechanism 112 includes a cavity first side 146, a cavity second side 148 and a cavity bottom 150. The cavity first side 146 and the cavity bottom 150 conjoin at angle e 152. The cavity second side 148 and the cavity bottom 150 conjoin at angle f 154.

In an example embodiment, angle c 142 is similar to angle e 152. Further, angle d 144 is similar to angle f such that the tooth 123 fits securely within the cavity 124.

In an example embodiment, the tooth base first side 130 is the same length as the tooth base second side 132. Further, angle a 138 is similar to angle b 140. Finally, the tooth base top 134 and the tooth base bottom 136 are parallel such that the tooth 123 is symmetrical.

In an example embodiment, the cavity first side 146 is similar to the cavity second side 148 and the angle e 152 is similar to angle f 154 such that the cavity is symmetrical.

In an example embodiment, the degree of angle c 142 and angle d 144 are larger than the degree of angle a 138 and angle b 140. Further, angle c 142 is similar to angle e 152 and angle d 144 is similar to angle f 154.

In an example embodiment, the degree of angle c 142, angle d 144, angle e 152 and angle f 154 is at least 90°.

In an example embodiment, the degree of angle c 142, angle d 144, angle e 152 and angle f 154 is between 90° and 180°.

In an example embodiment, the degree of angle a 138 and angle b 140 is above 0°.

In an example embodiment, the degree of angle a 138 and angle b 140 is between 0° and 90°.

The tooth 123 is configured to engage with the cavity 124. When the user pulls the side handle 114 and pushes the secondary lock 118, this causes the causes the latch 116 which is connected to the shaft 122 to move the shaft 122 in a way that disengages the tooth 123 from the cavity 124. The latch 116 is provided by securing the side handle 114 and the secondary lock 118 to the shaft 122. Pulling the side handle 114 and pushing the secondary lock 118 provides a rotational force around an axis 156. The rotational force around the axis 156 is converted to a translational force , translating to the shaft 122. The force translated to the shaft will be an opposing force than the force exerted by the user in the direction 126. The force translating to the shaft 122 causes the shaft 122 including the cavity 124 to disengage the tooth 123. As introduced above, the swivel base rotation mechanism 122 is in the unlocked position when the tooth 123 is disengaged from the cavity 124, allowing the user to rotate the rotating portion 106 of the seat 104 about the stationary portion 108.

Referring to FIG. 4, the swivel base rotation mechanism 112 automatically adjusts from the unlocked position to the locked position as the user rotates the rotating portion 106 of the seat 104 to a forward-facing configuration. In an illustrative example starting from the unlocked position, the user rotates the rotating portion 106 of the seat 104 to the locked position. As the rotating portion 106 of the seat 104 rotates to the forward-facing configuration, the cavity 124 contacts the tooth 123, forcing the tooth 123 upward against the force of the shaft 122. As the shaft 122 exerts further force on the tooth 123, the tooth 123 will be forced to reengage with the cavity 124. The amount of force required to reengage the tooth 123 with the cavity 124 will depend on the degree of angle c 142 or angle d 144.

As an illustrative example, the larger the degree of angle c 142 or angle d 144, the less force will be required to reengage the tooth 123 with the cavity 124.

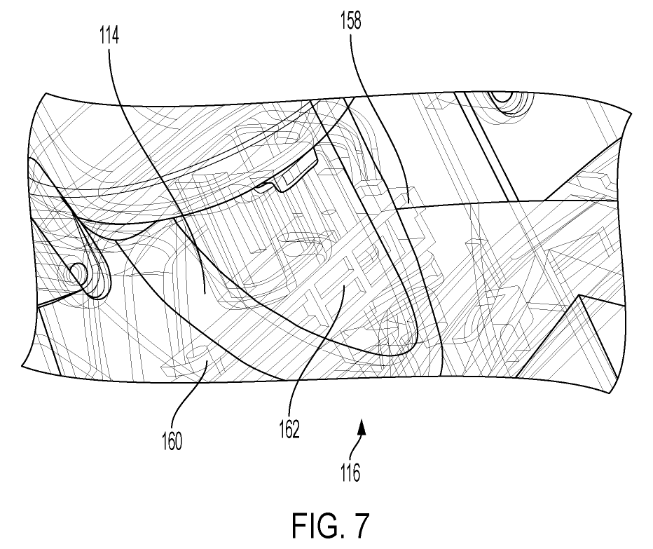

FIG. 7 illustrates a zoomed in view of the back of the second side handle and second secondary lock. The child seat 100 includes a swivel base rotation mechanism 112 which includes a latch 116. The latch 116 connects the side handle 114 and the secondary lock 118 to the shaft 122. The latch 116 includes a first latch end 158, a second latch end 160 and a latch body 162. The latch 116 is connected to the secondary lock 118 on the first latch end 158. The latch 116 is connected to the shaft 122 on the second latch end 160. The latch 116 is connected to the side handle 114 on the latch body 162.

As an illustrative example, the user can pull the pull the side handle 122 in a direction 126 and push the secondary lock 118 into the seat 104 to cause the rotating portion 108 of the seat 104 to be in an unlocked position. It is preferred but not required that the user pull the side handle 114 and push the secondary lock 118 into the seat 104 at the same or similar times. Moving on, when the user pulls the side handle 114 and pushes the secondary lock 118 into the seat 104 this provides a rotational force in around an axis 156 which translates to the latch 116. The rotational force around the axis 156 causes the first latch end 158 and the latch body 162 to move in the y-direction of the force which pushes the shaft in the x-direction of the force. The force translating to the shaft 122 causes the shaft 122 including the cavity 124 to disengage the tooth 123. As introduced above, the swivel base rotation mechanism 122 is in the unlocked position when the tooth 123 is disengaged from the cavity 124, allowing the user to rotate the rotating portion 106 of the seat 104 about the stationary portion 108.

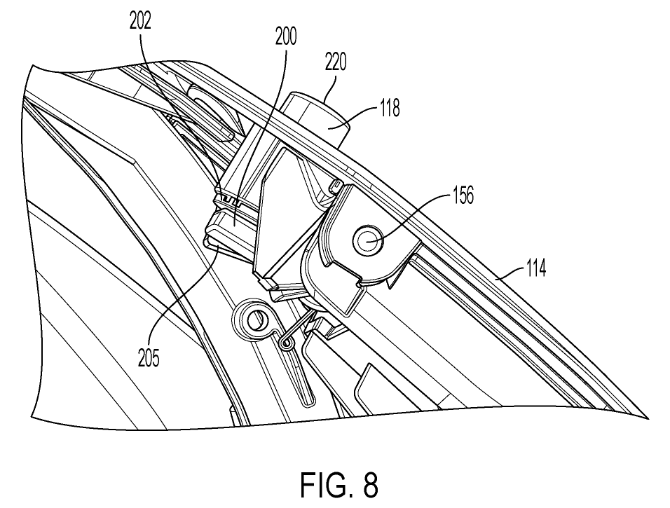

FIG. 8 illustrates a zoomed in top perspective view of an alternate secondary lock embodiment of the side handle and the secondary lock. The secondary lock 118 includes a lock blocker 200 and a side handle actuator 205. The secondary lock 118 also includes an interior face 202 and an outer face 220. The inner face 202 is configured to rest against the lock blocker 200, such that pressing the secondary lock 118 concurrently moves the lock blocker 200. Specifically, the lock blocker 200 and the side handle actuator 205 are vertically positioned around the axis 156. As such, when the user presses the secondary lock 118, the interior face 202 rotates the lock blocker 200 inwardly. The lock blocker 200 mechanically communicates with the side handle actuator 205, such that when the lock blocker 200 rotates inwardly, it engages with the side handle actuator 205 to enable it to freely rotate inwardly. In turn, the user is able to rotate the side handle 114 to cause the rotating portion 108 of the seat 104 to be in an unlocked position, and rotatable, as previously described.

Notably, the side handle actuator 205 mechanically couples the side handle 114, such that the side handle 114 can be rotated about the axis 156 when the side handle actuator 205 is rotated inwardly via the rotation of the lock blocker 200. In a resting position, the lock blocker 200 is configured to prevent the side handle actuator 205 from disengaging the side handle 114.

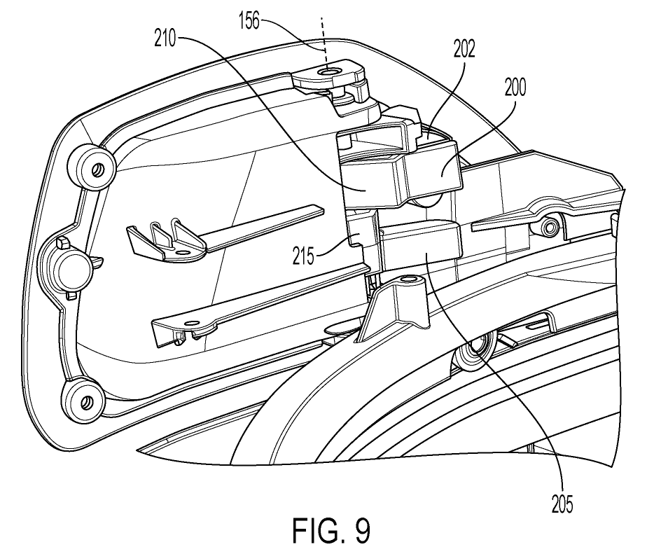

FIG. 9 illustrates a zoomed in bottom perspective view of the alternate secondary lock embodiment of the side handle and secondary lock. The lock blocker 200 includes a blocker base 210. The side handle actuator 205 includes an actuator base 215. The blocker base 210 can geometrically interlock with the actuator base 215 to enable rotation along the axis 156 when engaged, such that when the blocker base 210 rotates inwardly, the actuator base rotates 215 concurrently. As a result of the actuator base 215 rotating inwardly, the side handle actuator 205 can be turned by the user to rotate the child safety seat as described above.

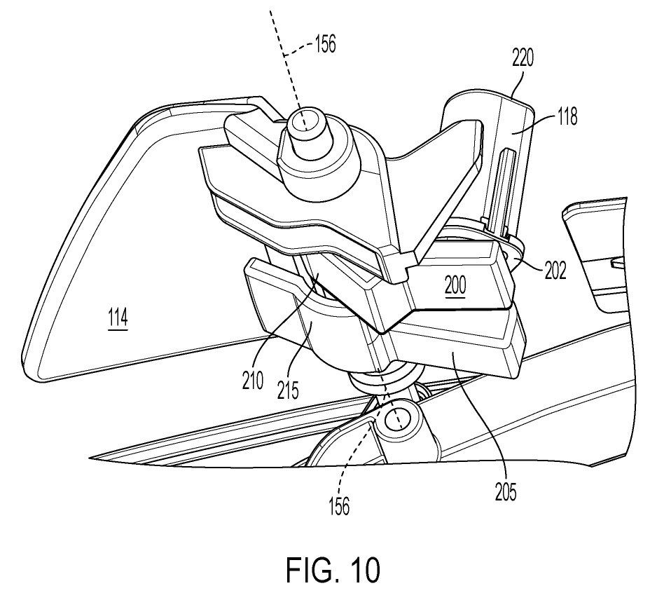

FIG. 10 illustrates a zoomed in side perspective view of the alternate secondary lock embodiment of the side handle and secondary lock. To disengage the side handle 114 from the stationary portion 108, and thereby rotate the seat, the user actuates the secondary lock 118 by pressing inward into the outer face 220 of the secondary lock 118. As the user presses the secondary lock 118, the inner face 202 of the secondary lock 118 rotates and presses into the lock blocker 200. As more pressure is applied to the lock blocker 200, the inward force causes the lock blocker 200 to rotate around the axis 156. This rotation engages the relationship between the blocker base 210 and the actuator base 215, wherein as the blocker base 210 is rotated, the actuator base 215 is forced to rotate as well around the axis 156. In turn, the entire side handle actuator 205 rotates around the axis 156, to mechanically couple with the side handle 114 to ‘activate’ the side handle 114 to rotate the child seat. In one embodiment, the user may pull on the side handle 114 at the same time they press down on the secondary lock 118 to be able to engage the side handle 114. In another embodiment, the user may only need to press the secondary lock 118, and separate engage the side handle 114.

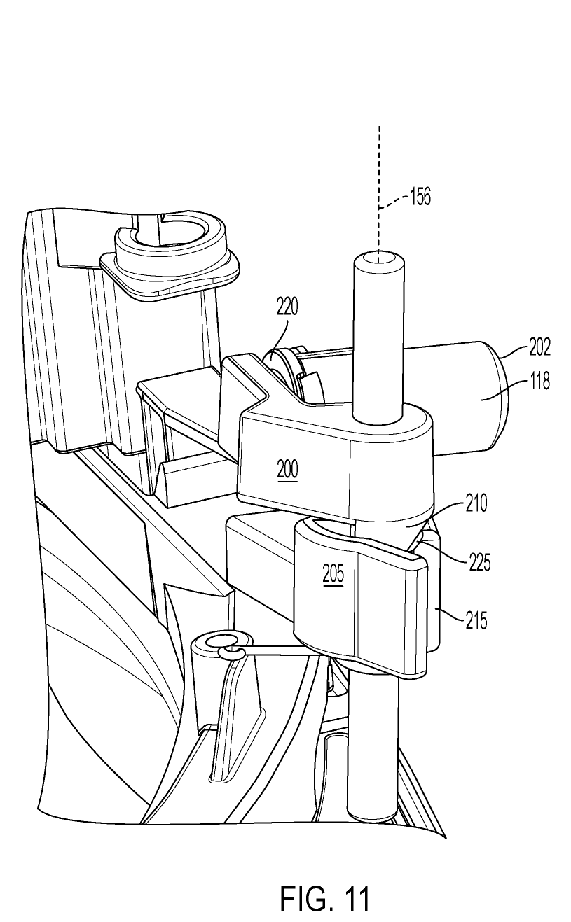

FIG. 11 illustrates an exploded view of the interlocking geometry between the lock blocker 200 and the side handle actuator 205. The blocker base 210 is configured to nestle within and around the actuator base 215 along the axis 156. The blocker base 210 and the actuator base 215 thus form a geometric configuration to create the sliding mechanism. The blocker base actuator base 215 includes an actuator ramp 225. The actuator ramp 225 is upwardly slanted and is configured to rest against the blocker base 210 along the axis 156. When a user decompresses the secondary lock 118, they cause inward pressure on the lock blocker 200. That inward force in turn creates a rotation that causes the blocker base 210 to slide up the actuator ramp 225. When the blocker base 210 slides up the actuator ramp 225, this sliding mechanism engages the actuator base 215, enabling it to also rotate along the axis 156. When the actuator base 215 rotates, so does the entirety of the side handle actuator 205, thereby mechanically coupling it with the side handle 114. For illustrative purposes, the side handle 114 has been removed from FIG. 11.

When the user releases pressure on the secondary lock 118, the secondary lock 118 returns to its outward, resting position. The secondary lock 118 may include a spring, a ball valve, or a spring plunger to return it to its resting position. When the secondary lock 118 is returned to its resting position, the inward force of the inner face 202 is removed from the lock blocker 200, causing the lock blocker 200 to then shift back to its resting position. As the entire lock blocker 200 returns to its resting position in the absence of an internal force, the blocker base 210 in turn slides down the actuator ramp 225 along the axis 156. This disengages the sliding mechanism between the blocker base 210 and the actuator base 215, resulting in the side handle actuator 205 to also return to its resting position. This resting position of the side handle actuator 205 prevents it from engaging the side handle 114. In an embodiment, the side handle 114 may also include an internal elastic component, like a spring, a ball valve, or a spring plunger, to orient the side handle back to a resting position.

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

1. A child seat configured to be secured to a car seat, the child seat comprising:
a seat pivotably coupled to a base, wherein the seat comprises a rotating portion and a stationary portion; and
a swivel base rotation mechanism, wherein the swivel base rotation mechanism is adjustable between a locked position and an unlocked position, wherein, in the locked position, the swivel base rotation mechanism prevents the seat from adjusting between a forward-facing configuration, a side facing configuration, and a rear facing configuration, and wherein, in the unlocked position, the seat is adjustable between the forward-facing configuration, the side facing configuration, and the rear facing configuration.

2. The child seat of claim 1, wherein the swivel base rotation mechanism comprises:
a shaft attached to the stationary portion;
a latch connected to the shaft;
a side handle coupled to the latch; and
a secondary lock coupled to the latch, wherein the side handle and the secondary lock are flush on the seat.

3. The child seat of claim 2, wherein, in response to rotating the handle around an axis and pushing the secondary lock into the seat, the latch moves the shaft, adjusting the swivel base rotation mechanism to the unlocked position.

4. The child seat of claim 3, wherein the latch has a first latch end, a second latch end, and a latch body; and
wherein the first latch is coupled to the secondary lock, the second latch end is coupled to the shaft, and the latch body is coupled to the side handle.

5. The child seat of claim 2, wherein the shaft comprises a cavity and the rotating portion comprised a tooth, wherein the cavity is configured to engage the tooth when the seat is in the locked position.

6. The child seat of claim 5, wherein, when the seat is in the unlocked position, the tooth is disengaged from the cavity.

7. The child seat of claim 1, wherein the base comprises an indicating window.

8. The child seat of claim 1, wherein the swivel base rotation mechanism comprises:
a first side handle, a second side handle, a first secondary lock, and a second secondary lock; wherein the first side handle and the first secondary lock is configured to adjust the swivel base rotation mechanism from the locked position to the unlocked position, and wherein the second side handle and the second secondary lock is configured to adjust the swivel base rotation mechanism from the locked position to the unlocked position.

9. The child seat of claim 1, wherein the swivel base rotation mechanism comprises a tooth base,
wherein the tooth base comprises a tooth base first side, a tooth base second side, a tooth base top, and a tooth base bottom.

10. The child seat of claim 5, wherein the cavity comprises a cavity first side, a cavity second side, and a cavity bottom.

11. A method of rotating child seat, a swivel base rotation mechanism, the child seat including a swivel base rotation mechanism, the child seat comprising a seat pivotably coupled to a base, wherein the seat comprises a rotating portion and a stationary portion; and a swivel base rotation mechanism, wherein the swivel base rotation mechanism is adjustable between a locked position and an unlocked position, wherein, in the locked position, the swivel base rotation mechanism prevents the seat from adjusting between a forward-facing configuration, a side facing configuration, and a rear facing configuration, and wherein, in the unlocked position, the seat is adjustable between the forward-facing configuration, the side facing configuration, and the rear facing configuration, wherein the swivel base rotation mechanism comprises:
a shaft;
a latch;
wherein the latch comprises a first latch end, a second latch end, and a latch body; and
wherein the second latch end is coupled to the shaft.

12. The method of claim 11, wherein the first latch end is coupled to a secondary lock.

13. The method of claim 11, wherein the latch body is coupled to a side handle.

14. The method of claim 11, wherein the shaft comprises a cavity.

15. The method of claim 14, wherein the cavity is configured to engage a tooth.

16. A swivel base rotation mechanism for use with a child safety seat, the swivel base rotation mechanism comprising:
a shaft attached to a stationary portion;
a latch connected to the shaft;
a side handle coupled to the latch; and
a secondary lock coupled to the latch, wherein the side handle and the secondary lock are flush on a child safety seat,
wherein the swivel base rotation mechanism is adjustable between a locked position and an unlocked position, wherein, in the locked position, the swivel base rotation mechanism prevents the child safety seat from adjusting between a forward-facing configuration, a side facing configuration, and a rear facing configuration, and wherein, in the unlocked position, the seat is adjustable between the forward-facing configuration, the side facing configuration, and the rear facing configuration.

17. The swivel base rotation mechanism of claim 16, wherein, in response to rotating the handle around an axis and pushing the secondary lock into the seat, the latch moves the shaft, adjusting the swivel base rotation mechanism to the unlocked position.

18. The swivel base rotation mechanism of claim 17, wherein the latch has a first latch end, a second latch end, and a latch body; and
wherein the first latch is coupled to the secondary lock, the second latch end is coupled to the shaft, and the latch body is coupled to the side handle.

19. The swivel base rotation mechanism of claim 17, wherein the shaft comprises a cavity and the rotating portion comprises a tooth, wherein the cavity is configured to engage the tooth when the child safety seat is in the locked position.

20. The swivel base rotation mechanism of claim 19, wherein, when the seat is in the unlocked position, the tooth is disengaged from the cavity.
